(19) United States
(12) Patent Application Publication
(10) Pub. No.: US 2023/0385856 A1
(43) Pub. Date: Nov. 30, 2023

(54) SYSTEM AND METHOD FOR DETERMINING LIFETIME VALUE OF USERS OF CLIENT APPLICATIONS

(71) Applicant: Skillz Platform Inc., San Francisco, CA (US)

(72) Inventors: Igor Szostak, San Francisco, CA (US); Costantinos Lambrinoudis, Vancouver (CA); Scott L. Gregoire, Portland, OR (US); Lillian Tong, San Francisco, CA (US)

(21) Appl. No.: 18/325,894

(22) Filed: May 30, 2023

Related U.S. Application Data
(60) Provisional application No. 63/347,329, filed on May 31, 2022.

(51) Int. Cl. G06Q 30/0202; G06N 20/00

(52) U.S. Cl. CPC G06Q 30/0202; G06N 20/00

(57) ABSTRACT

Methods, systems, and apparatus, including computer programs encoded on a computer storage medium, for determining lifetime value of users of client application. The method can include: receiving, first user data characterizing an interaction of a first user with a client application executing on a client device of the first user, first time interval data characterizing a first time interval associated with the first user, and second time interval data characterizing a second time interval associated with the first user, the first time interval characterizing a length of time that is shorter than a length of time characterized by the second time interval, determining, a first time interval lifetime value (LTV) of the first user based on the received first user data and the received first time interval data receiving historical long-term LTV data for a plurality of users of the client application, wherein each of the plurality of users has a respective first time interval LTV, converting, the received historical long-term LTV data into a transformation space, determining, using the converted historical long-term LTV data in the transformation space and the received second time interval data, a second time interval LTV for each of the plurality of users to generate a distribution of second time interval LTVs, generating, in the transformation space, a prediction of a second time interval LTV for the first user based on the distribution by matching the first time interval LTV of the first user with a respective first time interval LTV of one of the plurality of users, converting the prediction of the second time interval LTV for the first user back from the transformation space, and modifying a display of information to the first user within the client application when the prediction of the second time interval LTV for the first user satisfies a predetermined LTV threshold.

### CROSS-REFERENCE TO RELATED APPLICATIONS

This application claims the benefit of U.S. Provisional Application No. 63/347,329, filed May 31, 2022, the entire contents of which are hereby incorporated by reference herein.

### BACKGROUND OF THE INVENTION

Lifetime value (LTV) is a prediction of the revenue attributed to an ongoing relationship between a user and a product, such as a mobile application. By providing a running estimate on how much a particular user is likely to spend on the product, LTV can help ensure that companies pursue the most effective users. If a company can predict a user's LTV successfully, it can provide the company with a much better base from which to make decisions, which can help a company maximize the effectiveness of its user outreach efforts.

### SUMMARY

The present invention is directed to a system and method for determining lifetime value (LTV) of users of a client application. According to the present invention, short-term data can be used to predict long-term LTV of the users of the client application. In some implementations of the present invention, the prediction can be performed in a transformation space. The resulting prediction can be transformed back from the transformation space to generate the long-term LTV prediction for the user. In an embodiment, based on a predicted long-term LTV, an estimate can be made of the amount or potential revenue that can be generated by the user during their lifetime with respect to the client application using such short-term data. Accordingly, if the estimated potential revenue generated by the user is greater than or equal to a certain threshold or within certain thresholds, additional outreach campaigns can be presented to the user in or associated with the client application, since enhanced outreach campaigns directed to the user would be warranted.

Systems and methods for determining lifetime value of users of client applications are provided. Related apparatus, techniques, and articles are also described.

In an aspect, first user data characterizing an interaction of a first user with a client application executing on a client device of the first user, first time interval data characterizing a first time interval associated with the first user, and second time interval data characterizing a second time interval associated with the first user can be received by at least one data processor. The first time interval can characterize a length of time that is shorter than a length of time characterized by the second time interval. A first time interval lifetime value (LTV) of the first user can be determined by the at least one data processor based on the received first user data and the received first time interval data. Historical long-term LTV data for a plurality of users of the client application can be received by the at least one data processor, and each of the plurality of users can have a respective first time interval LTV. The received historical long-term LTV data into a transformation space by the at least one data processor. A second time interval LTV for each of the plurality of users can be determined by the at least one data processor using the converted historical long-term LTV data in the transformation space and the received second time interval data and to generate a distribution of second time interval LTVs. A prediction of a second time interval LTV for the first user based on the distribution can be generated by the at least one data processor in the transformation space by matching the first time interval LTV of the first user with a respective first time interval LTV of one of the plurality of users. The prediction of the second time interval LTV for the first user can be converted by the at least one data processor back from the transformation space. A display of information to the first user within the client application can be modified by the at least one data processor when the prediction of the second time interval LTV for the first user satisfies a predetermined LTV threshold.

One or more of the following features can be included in any feasible combination. For example, the prediction of the second time interval LTV can be generated using a random forest model. For example, the random forest model can be trained using the received historical long-term LTV data. For example, the received historical long-term LTV data can be converted into the transformation space using a Lambert W function. For example, a plurality of predictions of the second time interview LTV can be determined by the at least one data processor for the first user. For example, graphical data characterizing the plurality of predictions of a second time interval LTV for the first user can be generated by the at least one data processor. For example, a random forest regression model can be generated by the at least one data processor, in the transformation space, and based on the converted historical long-term LTV data. For example, a distribution of predictions of the second time interval LTV for the first user can be generated by the at least one data processor and using the random forest regression model generated in the transformation space. For example, the generated distribution of predictions of the second time interval LTV for the first user can be sampled by the at least one data processor, and a second distribution of predictions of the second time interval LTV for the first user can be generated by the at least one data processor. For example, a confidence interval characterizing the generated distribution of predictions of the second time interval LTV for the first user can be determined by the at least one data processor and based on the second distribution of predictions of the second time interval LTV for the first user.

In another aspect, a system is provided and can include at least one data processor and memory storing instructions, which, when executed by the at least one data processor, cause the at least one data processor to perform operations described herein. The operations can include receiving, by at least one data processor, first user data characterizing an interaction of a first user with a client application executing on a client device of the first user, first time interval data characterizing a first time interval associated with the first user, and second time interval data characterizing a second time interval associated with the first user, the first time interval characterizing a length of time that is shorter than a length of time characterized by the second time interval; determining, by the at least one data processor, a first time interval lifetime value (LTV) of the first user based on the received first user data and the received first time interval data; receiving, by the at least one data processor, historical long-term LTV data for a plurality of users of the client application, wherein each of the plurality of users has a respective first time interval LTV; converting, by the at least one data processor, the received historical long-term LTV data into a transformation space; determining, by the at least one data processor using the converted historical long-term LTV data in the transformation space and the received second time interval data, a second time interval LTV for each of the plurality of users to generate a distribution of second time interval LTVs; generating, by the at least one data processor in the transformation space, a prediction of a second time interval LTV for the first user based on the distribution by matching the first time interval LTV of the first user with a respective first time interval LTV of one of the plurality of users; converting, by the at least one data processor, the prediction of the second time interval LTV for the first user back from the transformation space; and modifying, by the at least one data processor, a display of information to the first user within the client application when the prediction of the second time interval LTV for the first user satisfies a predetermined LTV threshold.

One or more of the following features can be included in any feasible combination. For example, the prediction of the second time interval LTV can be generated using a random forest model. For example, the operations can further include training the random forest model using the received historical long-term LTV data. For example, the received historical long-term LTV data can be converted into the transformation space using a Lambert W function. For example, the operations can further include determining, by the at least one data processor, a plurality of predictions of the second time interval LTV for the first user. For example, the operations can further include generating, by the at least one data processor, graphical data characterizing the plurality of predictions of a second time interval LTV for the first user. For example, the operations can further include generating, by the at least one data processor, in the transformation space, and based on the converted historical long-term LTV data, a random forest regression model. For example, the operations can further include generating, by the at least one data processor and using the random forest regression model generated in the transformation space, a distribution of predictions of the second time interval LTV for the first user. For example, the operations can further include sampling, by the at least one data processor, the generated distribution of predictions of the second time interval LTV for the first user, and generating, by the at least one data processor, a second distribution of predictions of the second time interval LTV for the first user.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

### BRIEF DESCRIPTION OF THE DRAWINGS

The embodiments described above will be more fully understood from the following detailed description taken in conjunction with the accompanying drawings. The drawings are not intended to be drawn to scale. For purposes of clarity, not every component may be labeled in every drawing. In the drawings:

FIG. 1 is a block diagram illustrating an example system for predicting long-term lifetime value for users of a client application by using short-term lifetime value;

FIG. 2 is a flowchart illustrating an example method for predicting long-term lifetime value for users of a client application by using short-term lifetime value;

FIG. 3 is a flowchart illustrating an example method for predicting long-term lifetime value for users of a client application by using short-term lifetime value;

FIG. 4 is a flowchart illustrating an example method for predicting long-term lifetime value for users of a client application by using short-term lifetime value;

FIG. 5 is a flowchart illustrating an example method for predicting long-term lifetime value for users of a client application by using short-term lifetime value;

FIG. 6 is a graph illustrating an example extrapolation graph for predicting long-term lifetime value for users of a client application by using short-term lifetime value; and

FIG. 7 is a block diagram of an example computing device that may perform one or more of the operations described herein, in accordance with the present embodiments.

### DESCRIPTION OF THE INVENTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The present invention is directed to a system and method for determining lifetime value (LTV) of users of a client application. According to the present invention, short-term data can be used to predict long-term LTV of the users of the client application. In some implementations of the present invention, the prediction can be performed in a transformation space. The resulting prediction can be transformed back from the transformation space to generate the long-term LTV prediction for the user. In an embodiment, based on a predicted long-term LTV, the present invention can estimate the amount or potential revenue that can be generated by the user during their lifetime with respect to the client application using such short-term data. Accordingly, if the estimated potential revenue generated by the user is greater than or equal to a certain threshold or within certain thresholds, additional outreach campaigns can be presented to the user in or associated with the client application, since enhanced outreach campaigns directed to the user would be warranted. Embodiments of the present invention can support forecasting for whichever definition of LTV is chosen, can forecast at the user level, are able to vary the forecast horizon, and are able to be updated periodically, such as on a weekly basis or other suitable time period.

Merely for purposes of discussion and not limitation, the present disclosure can refer to digital games as an exemplary client application to illustrate various aspects of the present invention. However, the present invention can be used in and with any suitable type of client application (e.g., mobile applications, desktop applications, or any other appropriate types of client applications) in which users can spend currency (e.g., physical, electronic, virtual, digital, etc.) while engaging and interacting with the client application. For example, the LTV of a player in a digital game can be defined as the projected revenue that the player will generate during their lifetime in the digital game. However, the present invention can be used in and with any suitable type of client application for which calculation of long-term LTV of users is desired. For purposes of discussion and not limitation, the present disclosure will refer to “revenue” as a basis for the LTV calculations to illustrate various aspects of the present invention, although revenue can be substituted with any appropriate quantity. For example, merely for purposes of discussion, LTV can be the sum of discounted daily revenue, using the initial install date of or the date of first deposit in the client application as day one (D1).

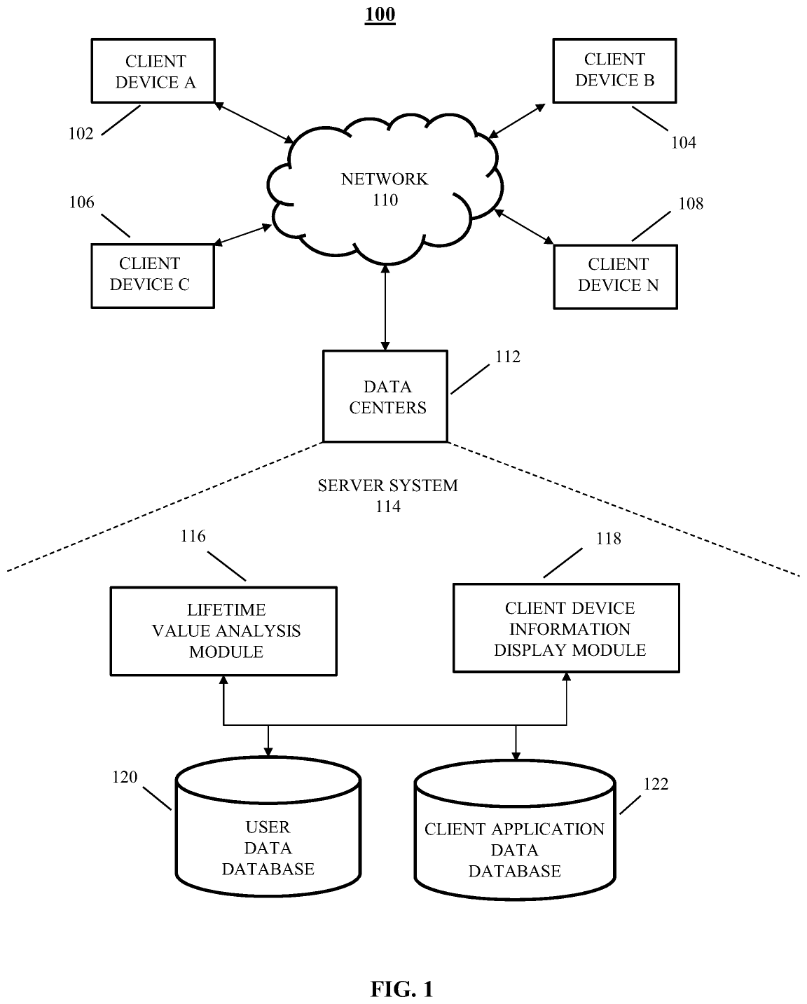

FIG. 1 is a block diagram illustrating an example system 100 for predicting long-term LTV for users of a client application by using short-term LTV. A server system 114 can provide functionality for receiving and collecting data associated with characteristics (e.g., revenue data and the like) of users in the client application, such as players in a digital game. The server system 114 can include software components and databases that can be deployed at one or more data centers 112 in, for example, one or more geographic locations. The software components of the server system 112 can include a lifetime value analysis module 116 and a client device information display module 118. The software components can include subcomponents that can execute on the same or on different individual data processing apparatus. The databases of the server system 114 can include, for example, a user data database 120 and a client application data database 122, although other databases are possible. The databases can reside in one or more physical storage systems or be cloud-based. The software components and databases will be further described below.

As illustrated in FIG. 1, the lifetime value analysis module 116 and the client device information display module 118 can communicate with each other and the user data database 120 and the client application data database 122. The user data database 120 can include, for example, any suitable information related to one or more users of client applications and the interactions between those users and the client applications, such as, for example, user LTV data (predicted, actual, short-term, long-term, etc.), user characteristics, user interaction history (e.g., in the context of digital games, which digital games were played, number of games won in each digital game, number of games lost in each digital game, number of games played for each digital game, scores in each digital game, time played for each digital game, etc.), user identifying information (e.g., usernames), a history of user connections to the system 100, user purchases, user accomplishments, user tasks, user interactions with other users (e.g., chats), user deposits/withdrawals, user virtual item acquisition or usage, other conditions in the client application, and the like. The client application data database 122 can include, for example, information related to the client applications implemented using the system 100. The client application data database 122 can include information related to each client application, such as, for example, a virtual environment for each client application, image, video, text, and/or audio data for each client application, event data corresponding to previous, current or future events, client application state data defining a current state of each client application, and the like.

A software application, such as, for example, a digital game or other web-based or suitable client application, can be provided as an end-user client application to allow users to interact with the server system 114. The software application can relate to and/or provide a wide variety of functions and information, including, for example, entertainment (e.g., a game, music, videos, etc.), business (e.g., word processing, accounting, spreadsheets, etc.), news, weather, finance, sports, etc. In some implementations of the present invention, the software application can provide a digital game. The digital game can be or include, for example, a sports game, an adventure game, a virtual playing card game, a virtual board game, a puzzle game, a racing game, or any other appropriate type of digital game. In an embodiment, the digital game can be an asynchronous competitive skill-based game, in which players can compete against each other in the digital game, but do not have to play the digital game at the same time. In an alternative embodiment, the digital game can be a synchronous competitive skill-based game, in which players can play the digital game at the same time and can compete against each other in the digital game in real-time. Other suitable software applications are possible.

The software application or components thereof can be accessed through a network 110 (e.g., the Internet) by users of client devices, such as client device A 102, client device B 104, client device C 106, . . . , client device N 108, where N can be any suitable natural number. Each of the client devices can be any appropriate type of electronic device that is capable of executing the software application and communicating with the server system 114 through the network 110, such as, for example, a smart phone, a tablet computer, a laptop computer, a desktop or personal computer, or the like. Other client devices are possible (e.g., portable or desktop game consoles, smart televisions, smart watches, and other like computing devices). In an alternative embodiment, the user data database 120, the client application data database 122, or any portions thereof can be stored on one or more client devices. Additionally or alternatively, software components for the system 100 (e.g., the lifetime value analysis module 116 and/or the client device information display module 118) or any portions thereof can reside on or be used to perform operations on one or more client devices.

In some implementations of the present invention, a user's LTV can represent how much currency (e.g., physical, electronic, virtual, digital, etc.) the user has spent in a client application. For example, in the context of a digital game, the user's LTV can represent how much money the user has spent in the digital game, minus any winnings or prizes the user may have been awarded. In an embodiment, each user can have their own LTV, and the value of their LTV can change with each transaction the user makes in the client application. In an embodiment, users who have not made a transaction or not otherwise deposited currency into the client application would not have an LTV. In some implementations of the present invention, the calculation of the user's LTV can commence from the first paid transaction in the client application (e.g., in the context of digital games, the first paid-entry competition fee) after the user makes their first deposit in the client application. Such an event can be referred to as a “first post-deposit transaction.” Alternatively, the calculation of the user's LTV can commence from the initial install of the client application. In an embodiment, the length of the calculated LTV can be specified with reference to a suitable time period, such as hours, days, weeks, months, etc. Merely for purposes of illustration and not limitation, the time period can be days, and the number of days can be counted starting from the user's first post-deposit transaction or initial install. For example, D1 LTV can refer to the sum of all relevant transactions within one day (24 hours) of the user's first post-deposit transaction or initial install, D2 LTV can refer to the sum of all relevant transactions within the first two days (48 hours) of the user's first post-deposit transaction or initial install, D7 LTV can refer to the sum of all relevant transactions within the first seven days of the user's first post-deposit transaction or initial install, and so forth. The transactional components which can be used to calculate the user's LTV (i.e., the transactions that can be considered when calculating a user's LTV) can depend on, for example, the client application and the types of transactions supported by the client application. For instance, in the context of digital games on a competitive, skill-based digital game platform, transactions such as paid entry fees from matches and tournaments can increase a user's LTV, while transactions such as cash prizes awarded for winning a match or tournament, refunds, physical prizes awarded or redeemed (e.g., from a reward or gift store), and the like can decrease a user's LTV. Other transactional components of a user's LTV are possible.

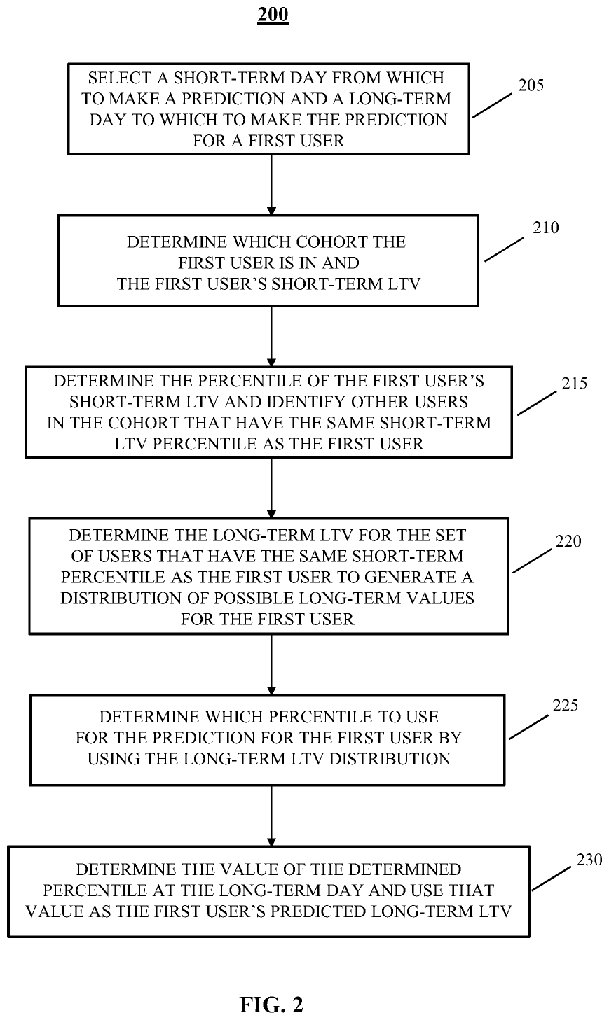

In some implementations of the present invention, the lifetime value analysis module 116 can use an XGBoost model or the like to predict a user's long-term LTV based on short-term LTV (e.g., starting from the user's first post-deposit transaction or initial install), although other suitable machine learning/artificial intelligence models can be used. FIG. 2 is a flowchart illustrating an example method 200 for predicting long-term LTV for users of a client application by using short-term LTV, in accordance with an embodiment of the disclosure. In some implementations of the present invention, the method 200 can be performed by, for example, the lifetime value analysis module 116 using an XGBoost model or the like. In an embodiment, the lifetime value analysis module 116 can monitor a plurality of users of a client application executing on respective client devices of the users. At block 205, the lifetime value analysis module 116 can select (or receive a selection of) a short-term day from which to make a prediction (e.g., D7, D30, or any other suitable time interval) and a long-term day to which to make the prediction (e.g., D90, D180, or any other suitable time interval) for a first user. Merely for purposes of illustration and not limitation, the lifetime value analysis module 116 can choose D180 for the long-term day and D7 for the short-term day for the first user. Thus, in the present illustration, the lifetime value analysis module 116 can predict LTV on day 180 after initial install of or first deposit in the client application based upon data up to and including day 7 after initial install of or first deposit in the client application by the first user, although any other suitable days or time periods or intervals can be chosen. At block 210, the lifetime value analysis module 116 can determine which cohort or group the first user is in or otherwise belongs to and the first user's short-term LTV, such as, for example, D7 LTV in the present illustration. For example, the lifetime value analysis model 116 can use data collected or otherwise received for the user (e.g., deposit and/or spending data retrieved from user data database 120) to determine the users short-term LTV (e.g., D7 LTV in the present illustration). For purposes of illustration and not limitation, in the context of digital games, users can be grouped into cohorts by digital game, platform, network, country, ad network, time to first deposit, withdrawal and maintenance fees paid, entry fees paid, first digital game played, number of digital games played, and/or the like or any combination thereof. Other cohorts or groups are possible and will depend on, for example, the type of client application, the types of users of the client application, how users interact or otherwise engage with the client application, and the like. Each cohort or group can be comprised of any suitable number of users. In an embodiment, the cohorts can be organized or otherwise optimized to reduce cohort-level error in the predicted long-term LTV. At block 215, the lifetime value analysis module 116 can determine the percentile of the first user's short-term LTV (e.g., D7 LTV), and identify other users in the cohort that have that same short-term LTV (e.g., D7 LTV) percentile as the first user, which could be all the users with the same percentile or an appropriately sized subset of such users in the cohort. In an alternative embodiment, instead of using an exact percentile, the lifetime value analysis module 116 can use, for example, the decile into which a user falls. In an embodiment, the width of the percentile range that is chosen can be a hyperparameter and can be chosen, for example, by suitable cross-validation (CV)/tuning. In a further alternative embodiment, the lifetime value analysis module 116 can predict the long-term LTV directly as a continuous value.

At block 220, the lifetime value analysis module 116 can determine the long-term LTV (e.g., D180 LTV) for the set of users that have the same or similar short-term LTV (e.g., D7 LTV) percentile as the first user (calculated at block 215) to generate a distribution of possible long-term values for the first user. In an embodiment, the lifetime value analysis module 116 can collect, retrieve, or otherwise receive historical long-term LTV data for the set of users for which long-term LTV data is available. The data from the set of users can be used for the purpose of training the machine-learning model (e.g., XGBoost or the like). In some implementations of the present invention, historical long-term LTV data for additional or alternative users other than those in the specified cohort or group of users can be used for training the machine-learning model. In an embodiment, the lifetime value analysis module 116 can retrieve the long-term LTV data from the user data database 120 for the set of users. The lifetime value analysis module 116 can delete any users of the set of users from the collected, retrieved, or received long-term LTV data that should not be considered (e.g., the user data is fraudulent, corrupted, disabled, or otherwise unusable). In some implementations of the present invention, the lifetime value analysis module 116 can perform a hyperparameter optimization on the long-term LTV data for the set of users. In a hyperparameter optimization, a plurality of models can be generated, each with random values for the number of trees, tree depth, regularization strength, and the like. The hyperparameters that result in the highest validation score as judged by the primary metric (e.g., total error in each cohort) can be used for retraining on the full dataset (e.g., training set plus validation set). In some implementations of the present invention, the primary metric can be calculated post-hoc, rather than directly optimized by the model. The model can be trained using, for example, the mean squared error or the like.

In an embodiment, the determination made by the lifetime value analysis module 116 can generate a distribution (e.g., histogram) of possible long-term LTVs (e.g., D180 LTVs) for the first user for whom a prediction is to be made. Thus, the lifetime value analysis module 116 can use the collected, retrieved, or received historical long-term LTV data for the set of users that have a same or similar short-term LTV as the first user to generate the distribution of possible long-term LTVs. In other words, the short-term LTV of the first user can be used to match the first user to the distribution of the long-term LTV having the same or similar short-term LTV as the first user. According to an alternative embodiment, instead of using an exact percentile, the lifetime value analysis module 116 can use, for example, the decile into which the first user falls. The width of the percentile range that is chosen can be a hyperparameter and can be chosen, for example, by suitable CV/tuning. In an alternative embodiment, the lifetime value analysis module 116 can predict the long-term LTV directly from the short-term LTV using a suitable regression model or the like. At block 225, the lifetime value analysis module 116 can determine which percentile is the most appropriate to use for the prediction for the first user by using the long-term LTV (e.g., D180 LTV) distribution (e.g., histogram) determined by the lifetime value analysis module 116 at block 220. For purposes of illustration and not limitation, the lifetime analysis module 116 can choose the 50^{th} percentile and predict using the median (or other suitable statistical calculation) of this distribution. Alternatively, for example, the lifetime analysis module 116 can choose the 70^{th} percentile instead to consistently predict a higher value. Other percentiles are possible. According to an embodiment, the percentile that is to be predicted can also be considered a hyperparameter and investigated with suitable CV/tuning. At block 230, the lifetime value analysis module 116 can determine the value (e.g., dollar amount or other monetary value) of the determined percentile at the long-term day (e.g., D180), and can use that value as the first user's predicted long-term LTV (e.g., D180 LTV). For example, if the value is a dollar (or other suitable currency) amount, the first user's predicted long-term LTV can be the projected revenue that the first user can generate during their lifetime in the client application. The lifetime value analysis module 116 can store the results in the user data database 120 for later retrieval and use.

In some implementations of the present invention, the lifetime value analysis module 116 can perform alternative steps for determining predictions with group-level, historical LTV distributions. The lifetime value analysis module 116 can choose a short-term day from which to make a prediction (e.g., D7, D30, or any other suitable time interval) and a long-term day to which to make a prediction (e.g., D90, D180, or any other suitable time interval) for the first user. Merely for purposes of illustration and not limitation, the lifetime value analysis module 116 can choose D180 as the long-term day and D7 as the short-term day for the first user. Thus, in the present illustration, the lifetime value analysis module 116 can predict LTV on day 180 after initial install of or first deposit in the client application based upon data up to and including data on day 7 after initial install of or first deposit in the client application by the first user, although any other suitable days can be chosen. The lifetime value analysis module 116 can determine which group that the first user is in (e.g., grouping users into cohorts by mobile application, platform, network, etc. as discussed above) and what is the first user's short-term LTV (e.g., D7 LTV) in the manner discussed above. The lifetime value analysis module 116 can determine the percentile of the first user's short-term LTV (e.g., D7 LTV). In some implementations of the present invention, the first user's LTV can be at the same percentile on the long-term day (e.g., D180). The lifetime value analysis module 116 can determine the value (e.g., dollar amount or other monetary amount) of the determined percentile at the long-term day (e.g., D180), and use that value as the first user's predicted long-term LTV (e.g., D180 LTV). For example, if the value is a dollar (or other suitable currency) amount, the first user's predicted long-term LTV can be the projected revenue that the user can generate during their lifetime in the client application. In an alternative embodiment, the lifetime value analysis module 116 can predict the long-term LTV directly using, for example, a regression model or the like based on or otherwise using features collected on the short-term day for the first user.

In some implementations of the present invention, the historical LTV can be broken out by relevant groups. For purposes of illustration and not limitation, consider that a digital gaming company's users can be divided into, for instance, Site, Network, Platform, and First-Game-Installed groups, although any other suitable groups and groupings of users are possible. After all users are grouped, then for each group the LTV curve for each user within that group can be calculated (e.g., by the lifetime value analysis module 116). Consequently, for each day, there can be a distribution of LTVs on that day, since each user can have their own LTV on that day. In an embodiment, the LTV can be potentially non-monotonic. For example, if the information is graphed for a specific group, “day” can be on the x-axis and LTV up to that day can be on the y-axis. After the daily LTV distributions are calculated for each group, then the training of an appropriate machine learning model can be performed. According to the present invention, two types of data can be used in such a model: time independent, in which all features fall into this category (e.g., platform, ad network, etc.); and time dependent (e.g., the target variable, such as revenue or the like).

LTV predictions can encounter extreme distributions of LTV data, which can exhibit fat or heavy tails and/or skew. The embodiment illustrated and discussed with respect to FIG. 2 can use such data to its advantage to reduce cohort-level error. However, in some implementations of the present invention, the lifetime value analysis module 116 can be implemented using a random forest model or the like to predict a user's long-term LTV based on short-term LTV (e.g., starting from the user's first post-deposit transaction or initial install), although other suitable machine learning/artificial intelligence models can be used (e.g., neural networks, etc.). Such an embodiment can be used for making LTV predictions more easily in the presence of large or otherwise extreme distributions of LTV data. Models trained with data exhibiting such extreme distributions can be biased by outliers to the detriment of overall predictive accuracy. In some implementations of the present invention, techniques for “gaussianizing” heavy-tailed distributions using the Lambert W function (also called the omega function or product logarithm) can be used for LTV data with large or extreme distributions. The Lambert W function can provide an explicit inverse transformation, which can be estimated by maximum likelihood. Such an inverse can remove heavy tails from data and also provide analytical expressions for the cumulative distribution function and the probability density function. Thus, the methodology according to some implementations of the present invention can be performed in the transformed space to more easily address LTV data with large or extreme distributions. In an embodiment, the Lambert transformation can be fitted to the training data (e.g., LTV data with large or extreme distributions), an appropriate model can be trained in the transformed space where the values are more “well-behaved,” and then the transformation can be inverted to return the predictions back to normal space (e.g., “cash” or “currency” space—the “heavy-tailed world”) for use in predicting the user's long-term LTV. Such a technique can allow embodiments of the present invention to make correct predictions on a wide variety of users in the data set (e.g., from small spenders to large spenders that can result in extreme distributions of LTV data) without cutting off values or biasing the model towards one group or the other. Although the Lambert W function can be used for fat- or heavy-tailed data, the choice of the transform will depend on the type of data being analyzed. For example, a log transform can be used for data with no negative values, while a power transform can be used for skewed data. Other transforms are possible.

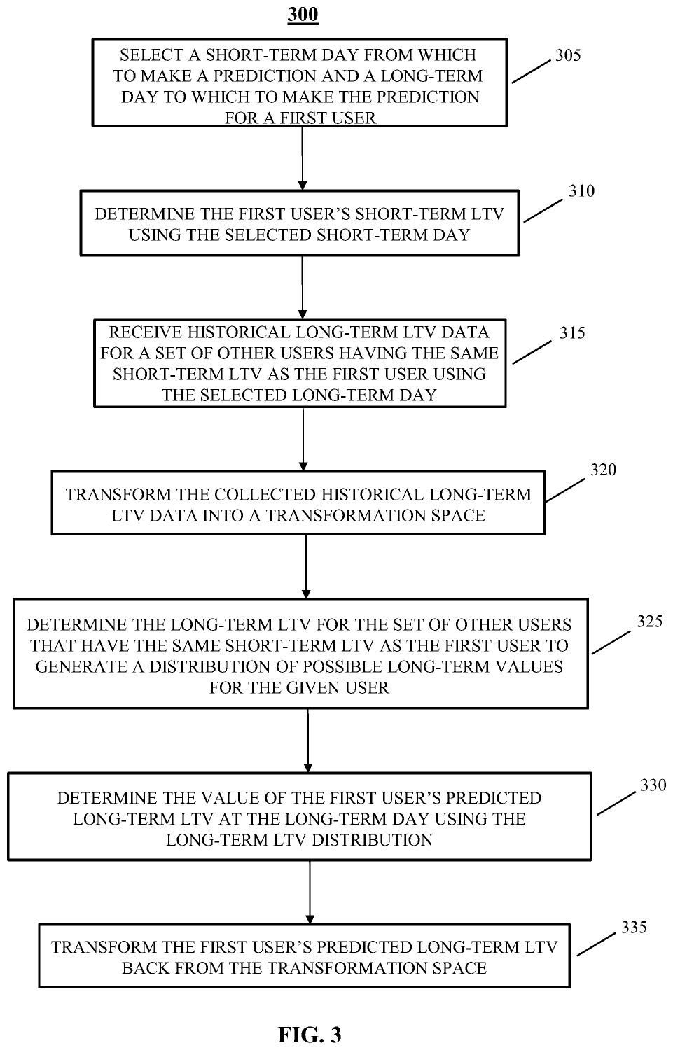

FIG. 3 is a flowchart illustrating an example method 300 for predicting long-term LTV for users of a client application by using short-term LTV, in accordance with an embodiment of the disclosure. In some implementations of the present invention, the method 300 can be performed by, for example, the lifetime value analysis module 116 using a random forest model or the like. As compared to an XGBoost model, a random forest model can allow for the use of an increased number of trees without overfitting. A random forest regression model can average the predictions from each tree to produce a final output. In an embodiment, the lifetime value analysis module 116 can treat each tree as an independent estimator of the mean LTV and use the independent estimators as an approximate long-term LTV distribution for each user. It is noted that in some implementations of the present invention the median of the approximate distribution can be a better estimate of the user's LTV than the mean due to, for example, skew and fat tails in the data, and the quantiles of the distribution can provide a higher confidence interval for the LTV predictions. However, although the median can provide a better estimate for each individual user, the median may not provide a better value for calculating the total LTV of cohorts of users. In situations where the individual LTV distributions can have a strong right-skew, the median can tend to underestimate the mean. However, in some implementations of the present invention in which the cohort LTV should take such skew into account, using the mean can work better than the median for cohorts of users, even though the median can work better for individuals.

In an embodiment, the lifetime value analysis module 116 can monitor a plurality of users of a client application executing on respective client devices of the users. At block 305, the lifetime value analysis module 116 can select (or receive a selection of) a short-term day from which to make a prediction and a long-term day to which to make the prediction for a first user. Merely for purposes of illustration and not limitation, the lifetime value analysis module 116 can choose D180 as the long-term day and D30 as the short-term day for the first user. Thus, in the present illustration, the lifetime value analysis module 116 can predict LTV on day 180 after initial install of or first deposit in the client application based upon data up to and including day 30 after initial install of or first deposit in the client application by the first user, although any other suitable days or time periods or intervals can be chosen for the long-term and short-term days. At block 310, the lifetime value analysis module 116 can determine the first user's short-term LTV (e.g., D30 LTV) using the selected short-term day and data received or otherwise collected for the user (e.g., deposit and/or spending data retrieved from user data database 120). At block 315, the lifetime value analysis module 116 can receive, collect, or otherwise retrieve historical long-term LTV data for a set of other users having the same or similar short-term LTV as the first user and for which long-term LTV data is available using the selected long-term day. The set of other users can be used for the purpose of training the machine-learning model (e.g., random forest model or the like), and can be comprised of users other than the first user for which the long-term LTV prediction is being made. In an embodiment, the lifetime value analysis module 116 can receive, collect, or otherwise retrieve the long-term LTV data from the user data database 120 for the set of other users. In an embodiment, the lifetime value analysis module 116 can delete any users of the set of other users from the collected or retrieved long-term LTV data that should not be considered (e.g., the user data is fraudulent, corrupted, disabled, or otherwise unusable).

At block 320, the lifetime value analysis module 116 can transform or otherwise convert the received historical long-term LTV data for the set of other users into a suitable transformation space. In an embodiment, a Lambert W function can be used as the transformation so that the long-term LTV data (e.g., LTV data with large or extreme distributions) can be more easily processed, although other suitable transformations can be used. In such an embodiment, the model's root-mean-squared error can be used in the transformed space, since this can represent how well the model performs across the whole data set. In some implementations of the present invention, the lifetime value analysis module 116 can perform a hyperparameter optimization on the long-term LTV data for the set of users. In a hyperparameter optimization, a plurality of models can be generated, each with random values for the number of trees, tree depth, regularization strength, and the like. The hyperparameters that result in the highest validation score as judged by the primary metric can be used for retraining on the full dataset (e.g., training set plus validation set). However, since random forest models have far fewer parameters than, for example, the XGBoost models and are far less sensitive to tuning, hyperparameter tuning is not necessary in the method 300 illustrated and discussed with respect to FIG. 3, although hyperparameter tuning can be used.

At block 325, the lifetime value analysis module 116 can determine the long-term LTV (e.g., D180 LTV) for the set of other users that have the same or similar short-term LTV (e.g., D30 LTV) as the first user (calculated for the first user at block 310) to generate a distribution of possible long-term values for the first user. In an embodiment, the determination made by the lifetime value analysis module 116 can be made in the transformation space to generate the distribution (e.g., histogram) of possible long-term LTVs (e.g., D180 LTVs) more easily for the first user for whom a prediction is to be made. Thus, the lifetime value analysis module 116 can use the received, collected, or otherwise retrieved historical long-term LTV data for the set of other users that have a same or similar short-term LTV as the first user to generate the distribution of possible long-term LTVs for the first user. In other words, the short-term LTV of the first user can be used to match the first user to the distribution of the long-term LTV of the other users having the same or similar short-term LTV as the first user. According to an alternative embodiment, the lifetime value analysis module 116 can predict long-term LTV using, for example, a suitable regression model or the like based on or otherwise using features received or collected from the short-term day for the first user. At block 330, the lifetime value analysis module 116 can determine the value of the first user's predicted long-term LTV (e.g., D180 LTV) at the long-term day using the long-term LTV distribution. For example, the lifetime value analysis module 116 can take the mean, median, percentile, or other suitable measure of the long-term LTV distribution to determine the value of the first user's long-term LTV. At block 335, the lifetime value analysis module 116 can transform or otherwise convert the first user's predicted long-term LTV back from the transformation space. For example, the lifetime value analysis module 116 can use an inverse of the transformation used in step 325 (e.g., an inverse of the Lambert W function or the like) to transform or otherwise convert the predictions back into non-transformed (i.e., normal) space. For purposes of illustration and not limitation, for predictions based on a monetary amount, the lifetime value analysis module 116 can invert the transformation to return the predictions to “cash” space. For instance, after inverse transformation, if the prediction value is a dollar (or other suitable currency) amount, the first user's predicted long-term LTV can be the projected revenue that the first user can generate during their lifetime in the client application. The lifetime value analysis module 116 can store the results in the user data database 120 for later retrieval and use.

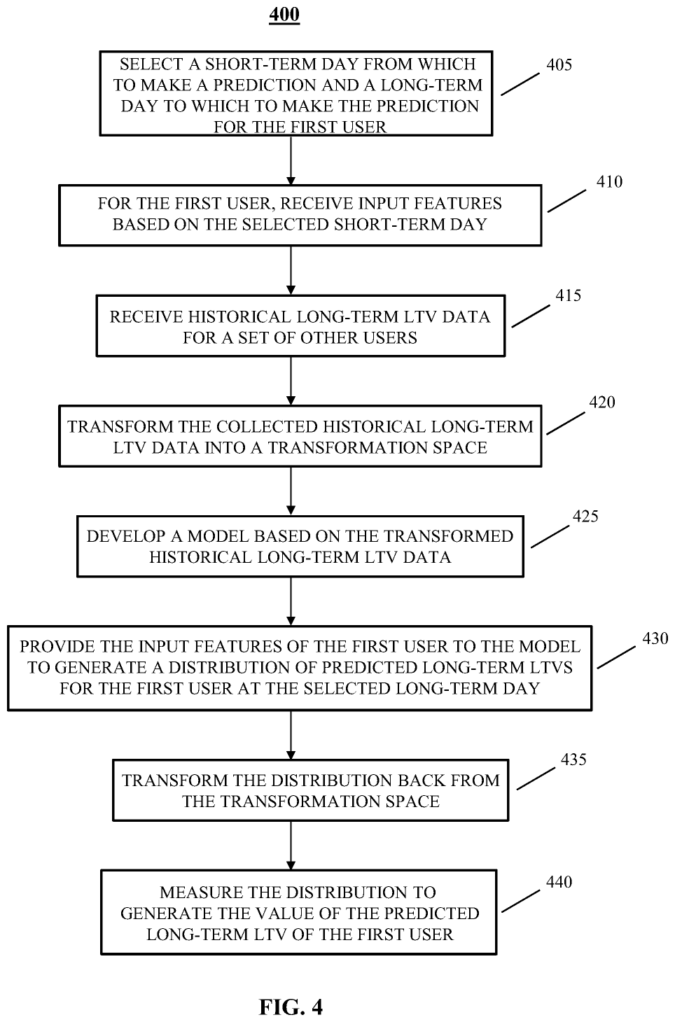

FIG. 4 is a flowchart illustrating an example method 400 for predicting long-term LTV for users of a client application by using short-term LTV, in accordance with an embodiment of the disclosure. In some implementations of the present invention, the method 400 can be performed by, for example, the lifetime value analysis module 116 using a random forest model or the like. In an embodiment, the lifetime value analysis module 116 can monitor a first user of a plurality of users of a client application executing on a client device of the first user. At block 405, the lifetime value analysis module 116 can select a short-term day from which to make a prediction and a long-term day to which to make the prediction for the first user. Merely for purposes of illustration and not limitation, the lifetime value analysis module 116 can choose D180 as the long-term day and D30 as the short-term day for the first user. Thus, in the present illustration, the lifetime value analysis module 116 can predict LTV on day 180 after initial install of or first deposit in the client application based upon data up to and including day 30 after initial install of or first deposit in the client application by the first user, although any other suitable days or time periods or intervals can be chosen. At block 410, the lifetime value analysis module 116 can receive, collect, or otherwise retrieve suitable input features for the first user based on the selected short-term day. For example, the lifetime value analysis module 116 can collect or otherwise generate the short-term LTV for the first user (e.g., D30 LTV), the number of interactions with the client application (e.g., in the context of digital games, the number of games played and the like), chat messages, or any other appropriate input features depending on the type of client application, the model being developed and used, and the like. At block 415, the lifetime value analysis module 116 can receive, collect, or otherwise retrieve historical long-term LTV data for a set of other users for which long-term LTV data is available. The set of other users can be used for the purpose of training the machine-learning model (e.g., random forest regression model or the like), and can be comprised of users other than the first user for which the long-term LTV prediction is being made. In an embodiment, the lifetime value analysis module 116 can retrieve the long-term LTV data from the user data database 120 for the set of other users. In an embodiment, the lifetime value analysis module 116 can delete any users of the set of other users from the collected or retrieved long-term LTV data that should not be considered (e.g., the user data is fraudulent, corrupted, disabled, or otherwise unusable).

At block 420, the lifetime value analysis module 116 can transform or otherwise convert the collected historical long-term LTV data into a suitable transformation space. In an embodiment, a Lambert W function can be used as the transformation so that the long-term LTV data (e.g., LTV data with large or extreme distributions) can be more easily processed, although other suitable transformations can be used. In such an embodiment, the model's root-mean-squared error can be used in the transformed space, since this can represent how well the model performs across the whole data set. At block 425, the lifetime value analysis module 116 can develop or otherwise create or build a model (e.g., a random forest regression model or the like) based on the transformed historical long-term LTV data. At block 430, the lifetime value analysis module 116 can provide the received or collected input features of the first user to the model to generate a distribution of predicted long-term LTVs for the first user at the selected long-term day (e.g., D180 LTVs). In an embodiment, the model can be developed or otherwise built and the distribution can be generated more easily by the lifetime value analysis module 116 in the transformation space when the LTV data exhibits large or extreme distributions. At block 435, the lifetime value analysis module 116 can transform or otherwise convert the distribution back from the transformation space. For example, the lifetime value analysis module 116 can use an inverse of the transformation used in step 420 (e.g., an inverse of the Lambert W function or the like) to convert the distribution back into non-transformed (i.e., normal) space. At block 440, the lifetime value analysis module 116 can measure the distribution (in the non-transformed space) to generate the value of the predicted long-term LTV of the first user. For example, the lifetime value analysis module 116 can take the mean, median, percentile, or other suitable measure of the long-term LTV distribution to determine the value of the first user's long-term LTV. The lifetime value analysis module 116 can store the results in the user data database 120 for later retrieval and use.

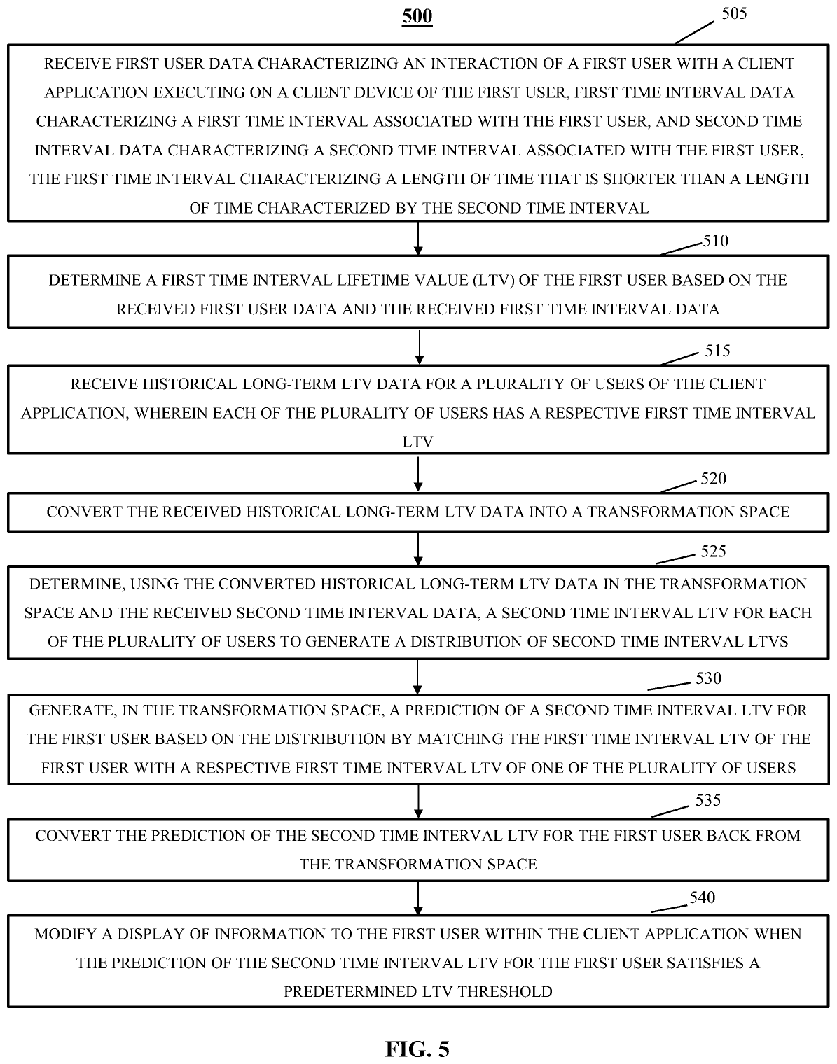

FIG. 5 is a flowchart illustrating an example method 500 for predicting long-term LTV for users of a client application by using short-term LTV, in accordance with an embodiment of the disclosure. In some implementations of the present invention, the method 500 can be performed by, for example, the lifetime value analysis module 116 using a random forest model or the like. In an embodiment, the lifetime value analysis module 116 can monitor a first user of a plurality of users of a client application executing on a client device of the first user. At block 505, the lifetime value analysis module 116 can receive first user data characterizing an interaction of a first user with a client application executing on a client device of the first user, first time interval data characterizing a first time interval associated with the first user, and second time interval data characterizing a second time interval associated with the first user. The first time interval can characterize a length of time that is shorter than a length of time characterized by the second time interval. At block 510, the lifetime value analysis module 116 can determine a first time interval LTV of the first user based on the received first user data and the received first time interval data. At block 515, the lifetime value analysis module 116 can receive historical long-term LTV data for a plurality of users of the client application. Each of the plurality of users can have a respective first time interval LTV. At block 520, the lifetime value analysis module 116 can convert or otherwise transform the received historical long-term LTV data into a transformation space. At block 525, the lifetime value analysis module 116 can determine, using the converted historical long-term LTV data in the transformation space and the received second time interval data, a second time interval LTV for each of the plurality of users to generate a distribution of second time interval LTVs. At block 530, the lifetime value analysis module 116 can generate, in the transformation space, a prediction of a second time interval LTV for the first user based on the distribution by matching the first time interval LTV of the first user with a respective first time interval LTV of one of the plurality of users. At block 535, the lifetime value analysis module 116 can convert or otherwise transform the prediction of the second time interval LTV for the first user back from the transformation space. At block 540, the lifetime value analysis module 116 can modify a display of information to the first user within the client application when the prediction of the second time interval LTV for the first user satisfies (e.g., is greater than or equal to) a predetermined LTV threshold.

In any or all of the embodiments illustrated in and discussed with respect to FIGS. 3, 4, and 5, the lifetime value analysis module 116 can predict on the long-term LTV (e.g., D180 LTV) directly. In an alternative embodiment, the lifetime value analysis module 116 can predict the difference between the long-term LTV (e.g., D180 LTV) and the short-term LTV (e.g., D30 LTV), and then add the short-term LTV (e.g., D30 LTV) back in at the conclusion to produce the long-term LTV (e.g., D180 LTV). Such an alternative embodiment can be used when a large percentage of users have permanently churned in the client application by the short-term day (e.g., D30), such that the difference for such users is zero. Consequently, it can be easier for a random forest model to split out the users who have churned and assign them a value of zero than it is to predict that their long-term LTV is identical to their short-term LTV.

According to embodiments of the present invention, the user's predicted long-term LTV can be used to determine which, if any, information can be displayed to the user within or associated with a client application executing on the client device of the user. In an embodiment, when the prediction of the user's long-term LTV is greater than or equal to a predetermined threshold or within certain predetermined thresholds (e.g., a predetermined dollar amount or projected revenue amount), the client device information display module 118 illustrated in FIG. 1 can be used to modify the display of information to the user within or associated with client application. Alternatively, when the prediction of the user's long-term LTV is less than a predetermined threshold or outside certain predetermined thresholds (e.g., a predetermined dollar amount or projected revenue amount), the client device information display module 118 illustrated in FIG. 1 can be used to modify the display of information to the user within or associated with the client application. The predetermined threshold can be any suitable amount or quantity. For example, if the user's predicted long-term LTV is the projected revenue that the user can generate during their lifetime in the client application, the predetermined threshold can be an appropriate dollar or revenue amount (e.g., $10, $50, $100, or like dollar amount).

In some implementations of the present invention, the client device information display module 118 illustrated in FIG. 1 can update, customize, modify, or otherwise personalize the graphical user interface, features, and/or functionality of the client application in any suitable manner. In an embodiment, the display of such personalized information can be used to increase the engagement and participation in the client application for users with predicted long-term LTVs that meet or exceed one or more predetermined thresholds. In an alternative embodiment, the display of such information can be used to increase the engagement and participation in the client application for users with predicted long-term LTVs that fall below one or more predetermined thresholds (e.g., in an attempt to increase their predicted long-term LTVs). For example, the client device information display module 118 can personalize any or all aspects of the graphical display of the client application (e.g., one or more graphical elements of the client application, such as any aspect of the “look and feel” of the graphical interface displayed by the client application), the information displayed within the client application, the features and/or functionality of the client application, and the like. Merely for purposes of illustration and not limitation in the context of a digital game, the client device information display module 118 can personalize the graphical display of the digital game to display, for example, player incentives, special offers (e.g., limited time offers or LTOs), advertisements or the like to a player inside or within the digital game. In the present illustration, different player incentives, special offers, advertisements, or the like can be displayed to a player in the digital game based on the player's predicted long-term LTV. Additionally or alternatively, client device information display module 118 can display or otherwise present additional and/or alternative prizes, rewards, and/or gifts to the player in an associated gift store for a client application. For example, a player with a predicted long-term LTV that is above a predetermined threshold or within certain predetermined thresholds may be presented with prizes, rewards, gifts, or the like in a gift store within or otherwise associated with a digital game that are different from prizes, rewards, gifts, or the like that may be presented to another player in the digital game who has a predicted long-term LTV that is below the predetermined threshold or outside certain predetermined thresholds or vice versa. In this manner, the menu or list of prizes, rewards, and/or gifts displayed to a player in the associated gift store can be tailored to players with predicted long-term LTVs relative to one or more predetermined threshold values. Additionally or alternatively, the client device information display module 118 can personalize, for example, graphical information displayed to the user outside of the client application, such as ads or offers surfaced to the user on their client device outside of the client application. However, in an embodiment, if the prediction of the user's long-term LTV is less than the predetermined threshold, no information (or less information) can be displayed to the user by the client device information display module 118.

As discussed previously, suitable machine learning/artificial intelligence techniques can be used to dynamically predict the long-term LTV of users from short-term LTV. For example, one or more machine learning models can be trained based on historical revenue data from all users of the client application (e.g., as retrieved from the user data database 120). The one or more machine learning models can then be used to dynamically predict a particular user's long-term LTV using the revenue data from the user population in accordance with the methods described herein. The one or more machine learning models can be updated or otherwise adapted as the revenue data of users changes or otherwise evolves over time. In an alternative embodiment, any or all of the predetermined values discussed above can be selected dynamically. According to the alternative embodiment, the lifetime value analysis module 116 can use suitable machine learning/artificial intelligence techniques to dynamically choose or otherwise select the appropriate values for any or all of the predetermined values and/or parameters discussed above. For example, one or more machine learning models can be trained based on data from either or both of the user data database 120 and client application data database 122. The one or more machine learning models can then be used to dynamically select the appropriate values for each or any of the aforementioned variables based on, for example, characteristics of the users (e.g., user revenue), characteristics of the client application (e.g., the type of client application), and other like characteristics or data. The one or more machine learning models can be updated or otherwise adapted as the characteristics, results, and other like data associated with the users and the client application change and evolve over time.

Thus, the embodiments illustrated and discussed above can use short-term data (e.g., D7, D30, or any other suitable time interval) to predict the long-term LTV (e.g., D180 or any other suitable time interval) for a user. In some implementations of the present invention, based on the predicted long-term LTV, the present invention can estimate the dollar amount or potential revenue that can be generated by the user during their lifetime in the client application using such short-term data. Accordingly, if the estimated potential revenue generated by the user is greater than or equal to a certain threshold or within certain thresholds, additional marketing campaigns and offers can be presented to the user in or associated with the client application, since enhanced marketing spend directed to the user would be warranted. It is noted that some implementations of the present invention do not have model parameters to estimate and in some implementations can use up to three or more hyperparameters for the alternative method to make predictions. Thus, in some implementations of the present invention, predictions can be made with the methods discussed and described in the present disclosure using appropriate CV/tuning. It is further noted that the present invention can predict out at a forecast horizon that is of similar length to the training data.

As long-term LTV is predicted at the user-level, in some implementations of the present invention the individual users can be grouped or otherwise organized into cohorts in any suitable manner, such as with respect to a client application or across different (but possibly related) client applications. Such groupings can support variations in, for example, experimentation and testing that cannot be accomplished if long-term LTV was predicted at the cohort-level. For example, individual users can be grouped according to any appropriate characteristic associated with the user, the client application, or the client device on which the client application is executing, such as user short-term LTV, user long-term LTV, user location, user age, user gender, type of client device (make, model, operating system, etc.), the genre of the client application, length of time the user has interacted or otherwise engaged with the client application, the progress made by the user in the client application, and the like. Once appropriately grouped, suitable experimentation and testing can be performed on the cohort (e.g., testing new features, new offers, etc.). The users can then be re-grouped into different cohorts to support variations on the experimentation and testing.

In some implementations of the present invention, bootstrapping can be performed on users. Bootstrapping is a statistical procedure that resamples a single data set to create many simulated samples. Such a process can allow for the calculation of standard errors, construction of confidence intervals, and performing hypothesis testing for numerous types of sample statistics. In the bootstrapping approach, a sample of size n is drawn from the population. The sample can be called S. Then, rather than using theory to determine all possible estimates, the sampling distribution is created by resampling observations with replacement from S m times, with each resampled set having n observations. Consequently, if sampled appropriately, S should be representative of the population. Therefore, by resampling S m times with replacement, it would be as if m samples were drawn from the original population, and the estimates derived would be representative of the theoretical distribution under the traditional approach. Increasing the number of resamples, m, will not increase the amount of information in the data. That is, resampling the original set, for example, 100,000 times is not more useful than resampling it, for example, 1,000 times. The amount of information within the set is dependent on the sample size, n, which will remain constant throughout each resample. The benefit of more resamples, then, is to derive a better estimate of the sampling distribution. In some implementations of the present invention, the lifetime value analysis module 116 can sample with replacement from the dataset of long-term LTV predictions (e.g., as stored in and retrieved from the user data database 120) a predetermined number of times (e.g., 1000 or the like) to create a set with an equivalent or similar number (e.g., 1000 or the like) of different long-term LTV predictions for the same user. The lifetime value analysis module 116 can then build or otherwise construct a confidence interval (e.g., for a 95% confidence interval, from 2.5 percentile to 97.5 percentile, although other confidence intervals are possible) to provide more and additional insight about the user long-term LTV to stakeholders.

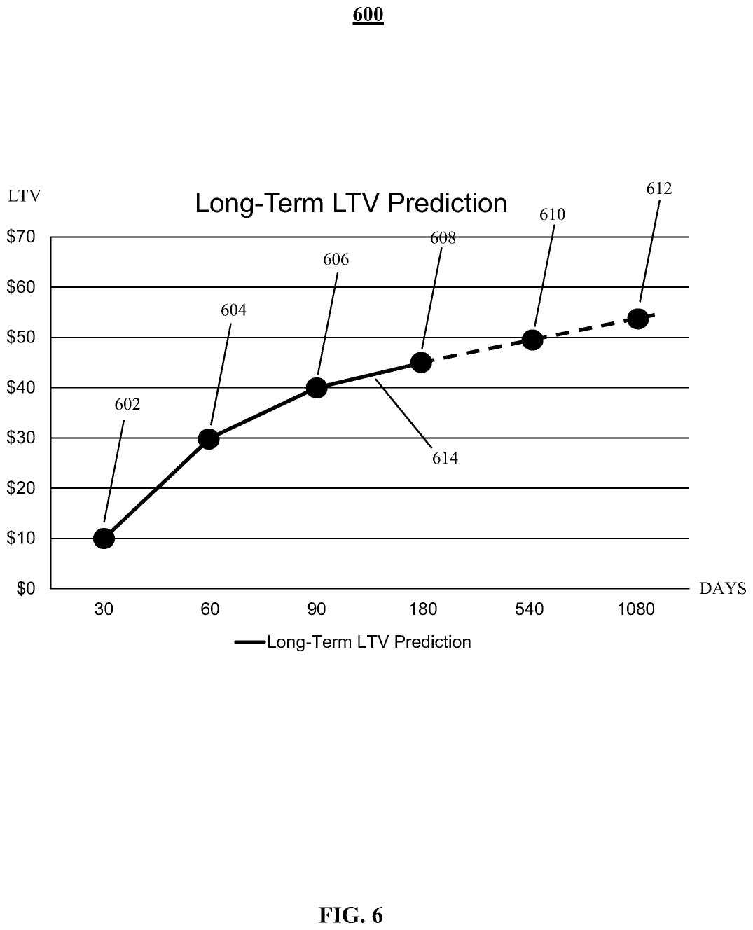

FIG. 6 is a graph illustrating an example extrapolation graph for predicting long-term LTV for users of a client application by using short-term LTV, in accordance with an embodiment of the disclosure. In some implementations of the present invention, a graph can be generated and used by the lifetime value analysis module 116 with, for example, “days” represented on the x-axis and the predicted long-term LTV (e.g., in dollars or other currency) represented on the y-axis. For purposes of illustration and not limitation, a graph 600 can illustrate the long-term LTV value predictions determined for a user of a client application according to the techniques and methodologies discussed above. For example, the user can have a first predicted long-term LTV 602 on day 30 of $10. The user can have a second predicted long-term LTV 604 on day 60 of $30. The user can have a third predicted long-term LTV 606 on day 90 of $40. The user can have a fourth predicted long-term LTV 608 on day 180 of $45. Additional and/or alternative long-term LTV data points and values in the graph 600 are possible, as the graph 600 can include any suitable number of long-term LTV data points. In some implementations of the present invention, one or more of the first predicted long-term LTV 602, the second predicted long-term LTV 604, the third predicted long-term LTV 606, and the fourth predicted long-term LTV 608 can be determined based on the machine learning models and/or transformation techniques discussed above using short-term LTV to predict long-term LTV. In an alternative embodiment, one or more of the first predicted long-term LTV 602, the second predicted long-term LTV 604, the third predicted long-term LTV 606, and the fourth predicted long-term LTV 608 can be the actual (rather than predicted) long-term LTV at each data point. In a further alternative embodiment, the first predicted long-term LTV 602, the second predicted long-term LTV 604, the third predicted long-term LTV 606, and the fourth predicted long-term LTV 608 can be any suitable mix or combination of predicted and actual long-term LTV data points.

In some implementations of the present invention, the shape or slope 614 of the curve in graph 600 at the latest prediction (in the present illustration, the fourth predicted long-term LTV 608) can then be used to extrapolate long-term LTV predictions for the user for any suitable time period in the future. For purposes of illustration and not limitation, based on the slope 614 of the curve of the graph 600 at the fourth predicted long-term LTV 608, a first extrapolated long-term LTV 610 on day 540 can be $50, while a second extrapolated long-term LTV 612 on day 1080 can be $55. Additional or alternative future extrapolations for predicted long-term LTV are possible based on the slope 614 of the curve in the graph 600. Additionally or alternatively, the extrapolated predictions of long-term LTV can be used for new users of the client application (e.g., new users with short-term and/or long-term LTV profiles similar to or the same as the existing user of graph 600 or based on other appropriate similar characteristics between the new users and existing users), in accordance with the techniques and methodologies discussed above.

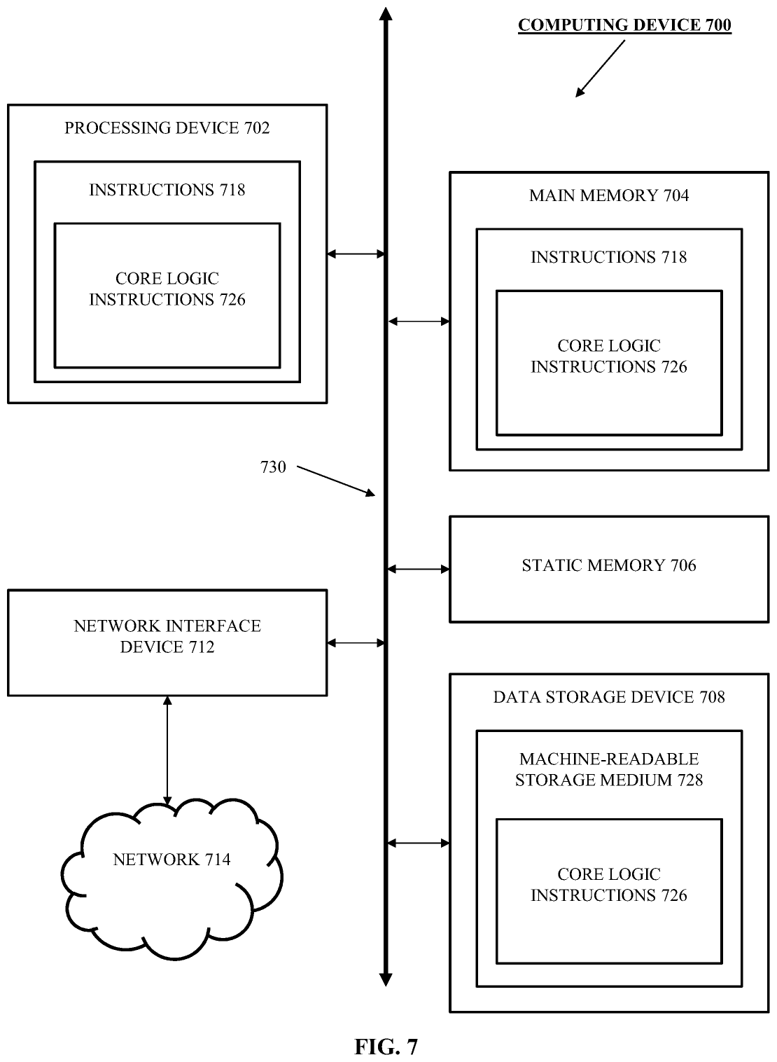

FIG. 7 is a block diagram of an example computing device 700 that may perform one or more of the operations described herein, in accordance with the present embodiments. The computing device 700 may be connected to other computing devices in a LAN, an intranet, an extranet, and/or the Internet. The computing device 700 may operate in the capacity of a server machine in client-server network environment or in the capacity of a client in a peer-to-peer network environment. The computing device 700 may be provided by a personal computer (PC), a set-top box (STB), a server, a network router, switch or bridge, or any machine capable of executing a set of instructions (sequential or otherwise) that specify actions to be taken by that machine. Further, while only a single computing device 700 is illustrated, the term “computing device” shall also be taken to include any collection of computing devices that individually or jointly execute a set (or multiple sets) of instructions to perform the methods discussed herein.

The example computing device 700 may include a computer processing device 702 (e.g., a general purpose processor, ASIC, etc.), a main memory 704, a static memory 706 (e.g., flash memory or the like), and a data storage device 708, which may communicate with each other via a bus 730. The computer processing device 702 may be provided by one or more general-purpose processing devices such as a microprocessor, central processing unit, or the like. In an illustrative example, computer processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 702 may also comprise one or more special-purpose processing devices, such as an application specific integrated circuit (ASIC), a field programmable gate array (FPGA), a digital signal processor (DSP), network processor, or the like. The computer processing device 702 may be configured to execute the operations described herein, in accordance with one or more aspects of the present disclosure, for performing the operations and steps discussed herein.

The computing device 700 may further include a network interface device 712, which may communicate with a network 714. The data storage device 708 may include a machine-readable storage medium 728 on which may be stored one or more sets of instructions, e.g., instructions for carrying out the operations described herein, in accordance with one or more aspects of the present disclosure. Instructions 718 implementing core logic instructions 726 may also reside, completely or at least partially, within main memory 704 and/or within computer processing device 702 during execution thereof by the computing device 700, main memory 704 and computer processing device 702 also constituting computer-readable media. The instructions may further be transmitted or received over the network 714 via the network interface device 712.

While machine-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media, magnetic media, and the like.

The subject matter described herein provides many technical advantages. For example, the server system 114 can scale to support concurrent long-term LTV determination for large numbers of individual users, such as hundreds of thousands, millions, tens of millions, or more users, thereby substantially improving computer resource allocation and processing efficiency. Thus, some implementations of the present invention can improve the efficiency and processing capabilities of computer hardware resources (e.g., computer processing and memory) to determine long-term LTV of individual users by supporting and provide substantially faster long-term LTV determination times, particularly for client applications with large numbers of users. For example, some implementations of the present invention can more efficiently handle the determination of long-term LTV for large numbers of users at the same time. By improving the long-term LTV determination speed and efficiency for client applications with large numbers of users, computer hardware resources can be freed up more quickly and used for other tasks and processes, resulting in a significant improvement in computer resource utilization.

Additionally, some implementations of the present invention can be used for making LTV predictions more easily in the presence of large or otherwise extreme distributions of LTV data. Models trained with data exhibiting such extreme distributions can be biased by outliers to the detriment of overall predictive accuracy. Embodiments of the present invention can make correct predictions on a wide variety of individual users in the data set (e.g., from small spenders to large spenders that can result in extreme distributions of LTV data) without cutting off values or biasing the model towards one group or the other, thereby improving the processing capabilities and efficiency of the server system 114. Embodiments of the present invention can also allow individual users to be grouped in any manner to provide granularity on the long-term LTV determinations, which cannot be accomplished when long-term LTV predictions are performed at the cohort level, thereby further improving the functionality and processing of the server system 114. Furthermore, some implementations of the present invention can allow for the testing of new features in client applications and how users respond to those new features. For example, when a new feature is introduced into a client application, if the corresponding predicted long-term LTV for users demonstrates an upward trend or other increase in long-term LTV, such determinations can be indicative of a positive user response to the new feature. Conversely, if the corresponding predicted long-term LTV for users demonstrates a downward trend or other decrease in long-term LTV, such determinations can be indicative of a negative user response to the new feature. Such feature testing can support improved functionality, processing, and efficiency in the server system 114, the client devices executing the client applications, and in the client applications themselves by reducing or eliminating unwanted, undesired, unused, and/or unneeded features and/or functionality from the client applications.

Embodiments of the subject matter and the operations described in this disclosure can be implemented in digital electronic circuitry, or in computer software, firmware, or hardware, including the structures disclosed in this disclosure and their structural equivalents, or in combinations of one or more of them. Embodiments of the subject matter described in this disclosure can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this disclosure can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, solid state drives, or the like. However, a computer need not have such devices. Moreover, a computer can be embedded in another device, e.g., a smart phone, a mobile audio or media user, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), LCD (liquid crystal display) monitor, a light emitting diode (LED) monitor, or the like, for displaying information to the user and a keyboard and a pointing device, e.g., a mouse, a trackball, a touchpad, a stylus, or the like, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like. In addition, a computer can interact with a user by sending resources to and receiving resources from a device that is used by the user; for example, by sending web pages to a web browser on a user's client device in response to requests received from the web browser.

Embodiments of the subject matter described in this disclosure can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), peer-to-peer networks (e.g., ad hoc peer-to-peer networks), and the like.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Reference throughout this disclosure to “one embodiment” or “an embodiment” means that a particular feature, structure, or characteristic described in connection with the embodiments included in at least one embodiment. Thus, the appearances of the phrase “in one embodiment” or “in an embodiment” in various places throughout this disclosure are not necessarily all referring to the same embodiment. In addition, the term “or” is intended to mean an inclusive “or” rather than an exclusive “or.”

While this disclosure contains many specific implementation details, these should not be construed as limitations on the scope of any inventions or of what may be claimed, but rather as descriptions of features specific to particular embodiments of particular inventions. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations and/or logic flows are depicted in the drawings and/or described herein in a particular order, this should not be understood as requiring that such operations and/or logic flows be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The above description of illustrated implementations of the invention is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. Other implementations may be within the scope of the following claims.

1. A method, comprising:
receiving, by at least one data processor, first user data characterizing an interaction of a first user with a client application executing on a client device of the first user, first time interval data characterizing a first time interval associated with the first user, and second time interval data characterizing a second time interval associated with the first user, the first time interval characterizing a length of time that is shorter than a length of time characterized by the second time interval;
determining, by the at least one data processor, a first time interval lifetime value (LTV) of the first user based on the received first user data and the received first time interval data;
receiving, by the at least one data processor, historical long-term LTV data for a plurality of users of the client application, wherein each of the plurality of users has a respective first time interval LTV;
converting, by the at least one data processor, the received historical long-term LTV data into a transformation space;
determining, by the at least one data processor using the converted historical long-term LTV data in the transformation space and the received second time interval data, a second time interval LTV for each of the plurality of users to generate a distribution of second time interval LTVs;
generating, by the at least one data processor in the transformation space, a prediction of a second time interval LTV for the first user based on the distribution by matching the first time interval LTV of the first user with a respective first time interval LTV of one of the plurality of users;
converting, by the at least one data processor, the prediction of the second time interval LTV for the first user back from the transformation space; and
modifying, by the at least one data processor, a display of information to the first user within the client application when the prediction of the second time interval LTV for the first user satisfies a predetermined LTV threshold.

2. The method of claim 1, wherein the prediction of the second time interval LTV is generated using a random forest model.

3. The method of claim 2, further comprising training the random forest model using the received historical long-term LTV data.

4. The method of claim 1, wherein the received historical long-term LTV data is converted into the transformation space using a Lambert W function.

5. The method of claim 1, further comprising determining, by the at least one data processor, a plurality of predictions of the second time interval LTV for the first user.

6. The method of claim 5, further comprising generating, by the at least one data processor, graphical data characterizing the plurality of predictions of a second time interval LTV for the first user.

7. The method of claim 1, further comprising generating, in the transformation space and based on the converted historical long-term LTV data, a random forest regression model.

8. The method of claim 7, further comprising generating, by the at least one data processor and using the random forest regression model generated in the transformation space, a distribution of predictions of the second time interval LTV for the first user.

9. The method of claim 1, further comprising:
sampling, by the at least one data processor, the generated distribution of predictions of the second time interval LTV for the first user; and
generating, by the at least one data processor, a second distribution of predictions of the second time interval LTV for the first user.

10. The method of claim 9, further comprising determining, by the at least one data processor and based on the second distribution of predictions of the second time interval LTV for the first user, a confidence interval characterizing the generated distribution of predictions of the second time interval LTV for the first user.

11. A system, comprising:
at least one data processor; and
memory storing instructions, which, when executed by the at least one data processor, cause the at least one data processor to perform operations comprising:
receiving, by at least one data processor, first user data characterizing an interaction of a first user with a client application executing on a client device of the first user, first time interval data characterizing a first time interval associated with the first user, and second time interval data characterizing a second time interval associated with the first user, the first time interval characterizing a length of time that is shorter than a length of time characterized by the second time interval;
determining, by the at least one data processor, a first time interval lifetime value (LTV) of the first user based on the received first user data and the received first time interval data;
receiving, by the at least one data processor, historical long-term LTV data for a plurality of users of the client application, wherein each of the plurality of users has a respective first time interval LTV;
converting, by the at least one data processor, the received historical long-term LTV data into a transformation space;
determining, by the at least one data processor using the converted historical long-term LTV data in the transformation space and the received second time interval data, a second time interval LTV for each of the plurality of users to generate a distribution of second time interval LTVs;
generating, by the at least one data processor in the transformation space, a prediction of a second time interval LTV for the first user based on the distribution by matching the first time interval LTV of the first user with a respective first time interval LTV of one of the plurality of users;
converting, by the at least one data processor, the prediction of the second time interval LTV for the first user back from the transformation space; and
modifying, by the at least one data processor, a display of information to the first user within the client application when the prediction of the second time interval LTV for the first user satisfies a predetermined LTV threshold.

12. The system of claim 11, wherein the prediction of the second time interval LTV is generated using a random forest model.

13. The system of claim 12, wherein the operations further comprise training the random forest model using the received historical long-term LTV data.

14. The system of claim 11, wherein the received historical long-term LTV data is converted into the transformation space using a Lambert W function.

15. The system of claim 11, wherein the operations further comprise determining, by the at least one data processor, a plurality of predictions of the second time interval LTV for the first user.

16. The system of claim 15, wherein the operations further comprise generating, by the at least one data processor, graphical data characterizing the plurality of predictions of a second time interval LTV for the first user.

17. The system of claim 11, wherein the operations further comprise generating, in the transformation space and based on the converted historical long-term LTV data, a random forest regression model.

18. The system of claim 17, wherein the operations further comprise generating, by the at least one data processor and using the random forest regression model generated in the transformation space, a distribution of predictions of the second time interval LTV for the first user.

19. The system of claim 11, wherein the operations further comprise:
sampling, by the at least one data processor, the generated distribution of predictions of the second time interval LTV for the first user; and
generating, by the at least one data processor, a second distribution of predictions of the second time interval LTV for the first user.

20. A non-transitory computer program product storing executable instructions, which, when executed by at least one data processor forming part of at least one computing system, implement operations comprising:
receiving, by at least one data processor, first user data characterizing an interaction of a first user with a client application executing on a client device of the first user, first time interval data characterizing a first time interval associated with the first user, and second time interval data characterizing a second time interval associated with the first user, the first time interval characterizing a length of time that is shorter than a length of time characterized by the second time interval;
determining, by the at least one data processor, a first time interval lifetime value (LTV) of the first user based on the received first user data and the received first time interval data;
receiving, by the at least one data processor, historical long-term LTV data for a plurality of users of the client application, wherein each of the plurality of users has a respective first time interval LTV;
converting, by the at least one data processor, the received historical long-term LTV data into a transformation space;
determining, by the at least one data processor using the converted historical long-term LTV data in the transformation space and the received second time interval data, a second time interval LTV for each of the plurality of users to generate a distribution of second time interval LTVs;
generating, by the at least one data processor in the transformation space, a prediction of a second time interval LTV for the first user based on the distribution by matching the first time interval LTV of the first user with a respective first time interval LTV of one of the plurality of users;
converting, by the at least one data processor, the prediction of the second time interval LTV for the first user back from the transformation space; and
modifying, by the at least one data processor, a display of information to the first user within the client application when the prediction of the second time interval LTV for the first user satisfies a predetermined LTV threshold.
